(19) United States
(12) Patent Application Publication
(10) Pub. No.: US 2009/0045649 A1
(43) Pub. Date: Feb. 19, 2009

(54) OVER ROAD TRAILER DOOR HINGE GAP SEALS

(75) Inventors: William C. Eungard, Waterford, WI (US); William E. Amundson, Pewankee, WI (US); Ralph W. Moody, New Berlin, WI (US); Keith Moore, Fort Worth, TX (US)

Correspondence Address: PERKINS COIE LLP;PATENT-SEA, P.O. BOX 1247, SEATTLE, WA, 98111-1247, US

(73) Assignee: 4Front Engineered Solutions, Inc.

(21) Appl. No.: 11/839,417

(22) Filed: Aug. 15, 2007

(51) Int. Cl. B62D 33/027

(52) U.S. Cl. 296/186.4

(57) ABSTRACT

Door gap seals and seal assemblies for over road trailers and other over road cargo carriers are disclosed herein. An over road trailer configured in accordance with one embodiment of the invention includes a door rotatably mounted to a container body proximate an opening. The door moves between a closed position in which the door at least partially covers the opening, and an open position in which the door is spaced apart from the opening to form a gap therebetween. The over road trailer further includes a seal attached to at least one of the door and the container body. The seal is at least partially compressed and/or deflected between the door and the container body to seal the gap when the door is in the open position.

### TECHNICAL FIELD

The present disclosure relates generally to devices that can be used to at least partially seal a hinge gap between a door and a container body on an over road trailer or other type of over road cargo container.

### BACKGROUND

Delivery vehicles typically back up to a loading dock to load and unload cargo. Semi-trailer trucks, for example, typically back a container carried on the trailer up to a loading dock that includes a shelter to provide a weather seal between the container and the loading dock. The rear doors of the container are typically opened and secured to the sides of the container prior to backing into the shelter.

FIG. 1, for example, is an isometric view of a conventional semi-truck trailer 101. The semi-truck trailer 101 includes a container body 102 with an opening 104 that provides access to an interior 106. The semi-truck trailer 101 (“trailer 101”) also includes a first door 110a and a second door 110b that cover the opening 104 when closed. A plurality of hinges 120 rotatably attach the doors 110 to the container body 102, and allow the doors 110 to rotate between the open position (shown) and the closed position. When the doors 110 are in the open position illustrated in FIG. 1, the hinges 120 create a first gap 130a and a second gap 130b between the first door 110a and the second door 110b, respectively, and the adjacent container surface 108. As explained below with reference to FIG. 2, the gaps 130 form a substantial leak path between the interior 106 of the container body 102 and the outside environment. The gaps 130 also form a substantial leak path from the loading dock building to the outside environment.

FIG. 2 is a cross-sectional top view of the trailer 101 backed up to a conventional loading dock 200. The loading dock 200 includes a plurality of dock bumpers 206 that are mounted to a dock wall 204 to abut the trailer 101. The loading dock 200 also includes a shelter 210 with curtains 212. As illustrated in FIG. 2, the curtains 212 seal against the opened trailer doors 110, rather than the exterior container surface 108. As a result, the gaps 130 between the doors 110 and the container body 102 are left open to the outside environment and can allow wind, rain, snow and/or other undesirable elements to pass into the loading dock 200 or the interior 106 of the container body 102. These elements can cause problems, such as damage to the cargo in the container body 102. Hot or cold air can also enter or escape from the loading dock 200, thereby increasing building air conditioning costs. The gaps 130 can also create security concerns as items may be passed into or out of the container body 102 through the gaps 130 by unscrupulous persons.

Prior methods of sealing the gaps 130 include engaging the container opening with a hook-shaped device that covers the gap as the container is backed up to the loading dock. Engaging the container with such a device, however, is complicated because of variations in container sizes, as well as differences in the thicknesses of the doors and hinges. Another challenge associated with this approach is that the device must seal around the castellated hingeline of the trailer doors. For example, when the doors 110 are opened as illustrated in FIG. 2, the hinges 120 protrude from the rear edges of the container body 102 creating uneven, castellated edges. In addition, the number of hinges, as well as the location and size of the hinges, can vary between different container manufacturers. A further difficulty associated with engaging the container with a cover or other type of shelter is that if the container body is off-center when it is backed up to the loading dock, the shelter will be misaligned and thus unable to properly seal the gaps.

### SUMMARY

The following summary is provided for the benefit of the reader only, and is not intended to limit in any way the disclosure as set for by the claims.

The present disclosure is directed generally to devices for at least partially sealing or occluding a gap between a door and a container body on an over road trailer or other type of shipping vehicle. One aspect of the disclosure is directed toward an over road trailer having a door rotatably mounted to a container body proximate to an opening. The door moves between a closed position in which the door at least partially covers the opening, and an open position in which the door is spaced apart from the opening to form a gap therebetween. The over road trailer further includes a seal attached to at least one of the container body and the door. When the door is in the open position, the seal is at least partially deflected and/or compressed between the door and the container body to at least partially seal the gap.

Another aspect of the disclosure is directed to an over road cargo container having at least one hinge attached to a container body proximate to an opening of the container body. A door is rotatably mounted on the hinge and is movable between a closed position in which the door at least partially encloses the opening, and an open position in which the hinge spaces an edge portion of the door apart from the opening to form a gap. In this aspect of the disclosure, the trailer further includes a seal assembly attached to at least one hinge. The seal assembly contacts the container body and the door when the door is in the open position and at least partially seals or covers the gap.

A further aspect of the disclosure is directed to a semi-trailer truck having a semi-trailer operably coupled to a road tractor. The semi-trailer carries a container body having an opening therein. The semi-trailer also includes a door rotatably mounted to the container body at least proximate to the opening. The door is movable between a closed position in which the door at least partially covers the opening and an open position in which the door is spaced apart from the opening. The semi-trailer further includes a seal assembly attached to at least one of the container body and the door. The seal assembly extends between the container body and the door when the door is in the open position to at least partially seal the gap.

Another aspect of the disclosure is directed to a system for shipping cargo over the road by truck. The system includes a container configured to be attached to a truck. The system also includes means for rotatably mounting a door proximate to an opening in the container. The door moves between a closed position in which the door at least partially covers the opening and an open position in which the door is spaced apart from the opening to form a gap therebetween. The system further includes means for at least partially occluding the gap when the door is in the open position. The means for at least partially occluding are fixedly attached to at least one of the door and the container.

### BRIEF DESCRIPTION OF THE DRAWINGS

FIG. 1 is an isometric view of an aft portion of a conventional semi-truck trailer configured in accordance with the prior art.

FIG. 2 is a cross-sectional top view of the semi-truck trailer of FIG. 1 backed up to a conventional loading dock shelter.

FIG. 3 is an isometric view of an aft portion of an over road trailer having door seals configured in accordance with an embodiment of the invention.

FIGS. 4A and 4B are enlarged cross-sectional top views taken along line 4-4 in FIG. 3 showing the door seal during two stages of door operation.

FIGS. 5A and 5B are enlarged cross-sectional top views showing a door seal configured in accordance with another embodiment of the invention during two stages of door operation.

FIGS. 6A and 6B are enlarged cross-sectional top views showing a door seal assembly configured in accordance with a further embodiment of the invention during two stages of door operation.

FIGS. 7A and 7B are enlarged cross-sectional top views showing a door seal assembly configured in accordance with yet another embodiment of the invention during two stages of door operation.

FIGS. 8A and 8B are enlarged cross-sectional top views showing a door seal configured in accordance with a further embodiment of the invention during two stages of door operation.

FIGS. 9A and 9B are enlarged cross-sectional top views showing a door seal configured in accordance with yet another embodiment of the invention during two stages of door operation.

FIG. 10A is an isometric view of an aft portion of an over road trailer having door seal assemblies configured in accordance with a further embodiment of the invention.

FIG. 10B is an enlarged isometric view of the door seal assembly of FIG. 10A.

FIGS. 11A and 11B are enlarged cross-sectional top views taken along line 11-11 in FIG. 10A showing the door seal assembly during two stages of door operation.

FIG. 12 is an isometric view of an aft portion of an over road trailer having door seal assemblies configured in accordance with a further embodiment of the invention.

FIG. 13 is an enlarged cross-sectional top view taken along line 13-13 in FIG. 12 showing the door seal assembly in one stage of door operation.

FIG. 14 is a rearward isometric view of an aft portion of an over road trailer having a door seal configured in accordance with yet another embodiment of the invention.

FIG. 15 is a side view of a removable door seal configured in accordance with a further embodiment of the invention.

FIG. 16 is a side view of a removable door seal configured in accordance with yet another embodiment of the invention.

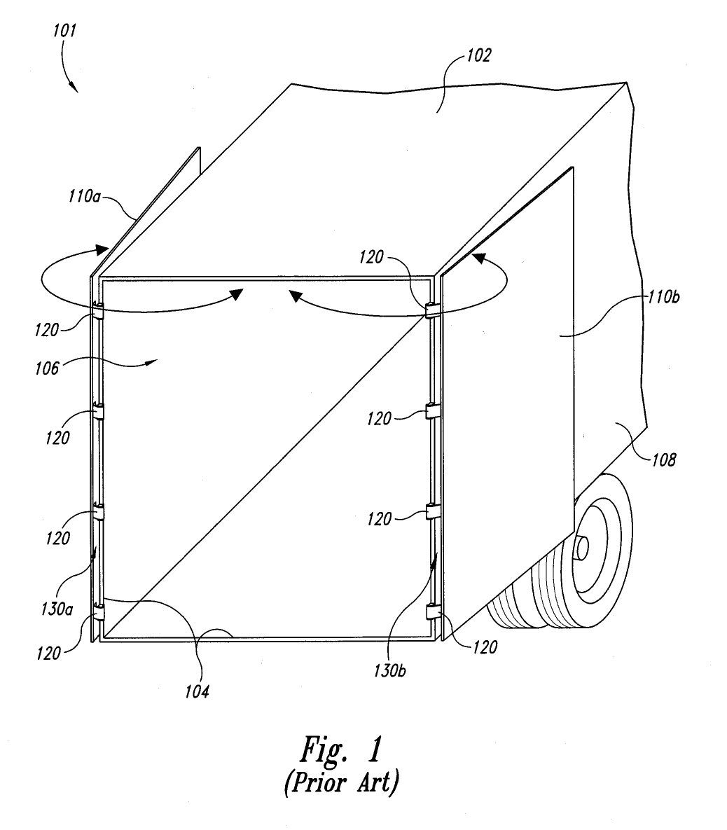

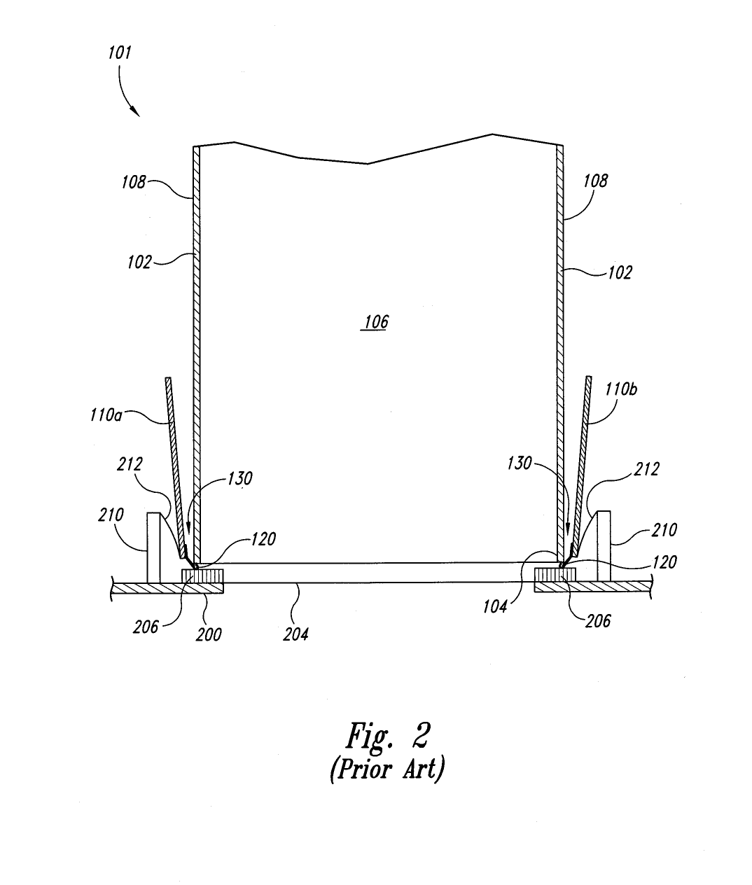

### DETAILED DESCRIPTION

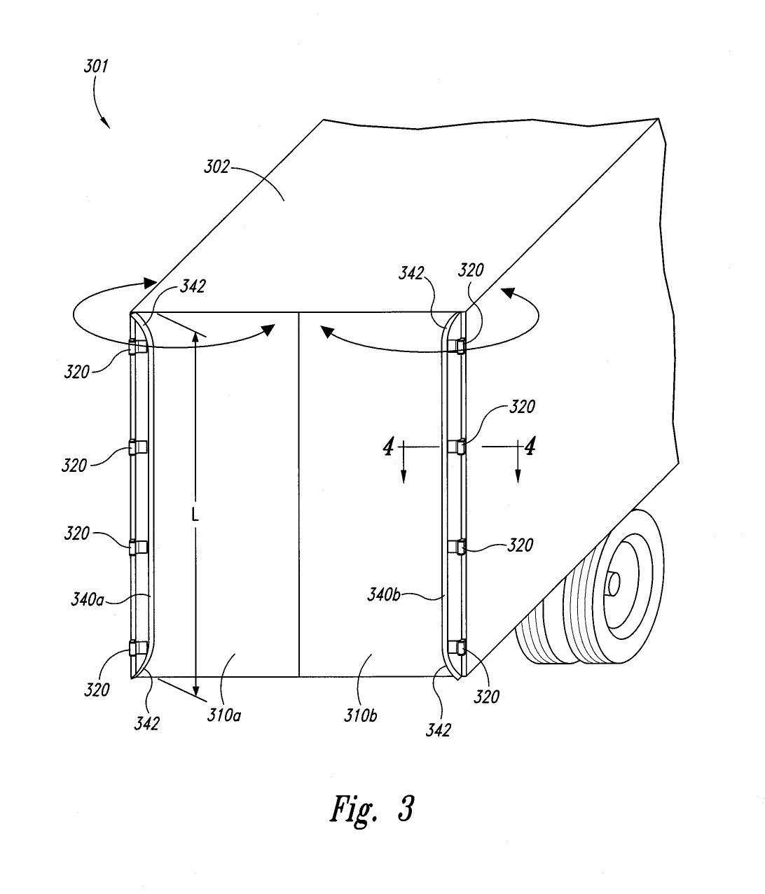

The following disclosure describes several embodiments of devices for at least partially sealing, covering, or otherwise occluding gaps between doors and container bodies on semi-truck trailers and other types of over road cargo carriers when the doors are in the open position. In one embodiment, for example, a seal is at least partially deflected or compressed between the container body and the door when the door is in the opened position. Certain details are set forth in the following description and in FIGS. 3-16 to provide a thorough understanding of various embodiments of the invention. Other details describing well-known structures and systems often associated with over road trailers, loading docks, etc. have not been set forth in the following disclosure to avoid unnecessarily obscuring the description of the various embodiments of the invention.

Many of the details and configurations shown in the Figures are merely illustrative of particular embodiments of the invention. Accordingly, other embodiments can have other details or configurations without departing from the spirit or scope of the present invention. In addition, those of ordinary skill in the art will appreciate that further embodiments of the invention can be practiced without several of the details described below.

In the Figures, identical reference numbers identify identical, or at least generally similar, elements. To facilitate the discussion of any particular element, the most significant digit or digits of any reference number refer to the Figure in which that element is first introduced. For example, element 310 is first introduced and discussed with reference to FIG. 3.

FIG. 3 is an isometric view of an aft portion of an over road trailer 301 having two door seals 340 (identified individually as a first seal 340a and a second seal 340b) configured in accordance with an embodiment of the invention. In the illustrated embodiment, the over road trailer 301 (“trailer 301”) is a semi-truck trailer. In other embodiments, however, the door seals 340 can be used with other types of shipping containers and other types of cargo carriers including, for example, delivery trucks, vans, trains, ships, etc. The trailer 301 includes rear doors 310 (identified individually as a first door 310a and a second door 310b) rotatably mounted to a container body 302 by a plurality of hinges 320. The hinges 320 allow the doors 310 to rotate between a closed position shown in FIG. 3, in which the doors cover an opening in the rear portion of the trailer 301, and an open position that provides access into the interior of the container body 302 to load and unload cargo.

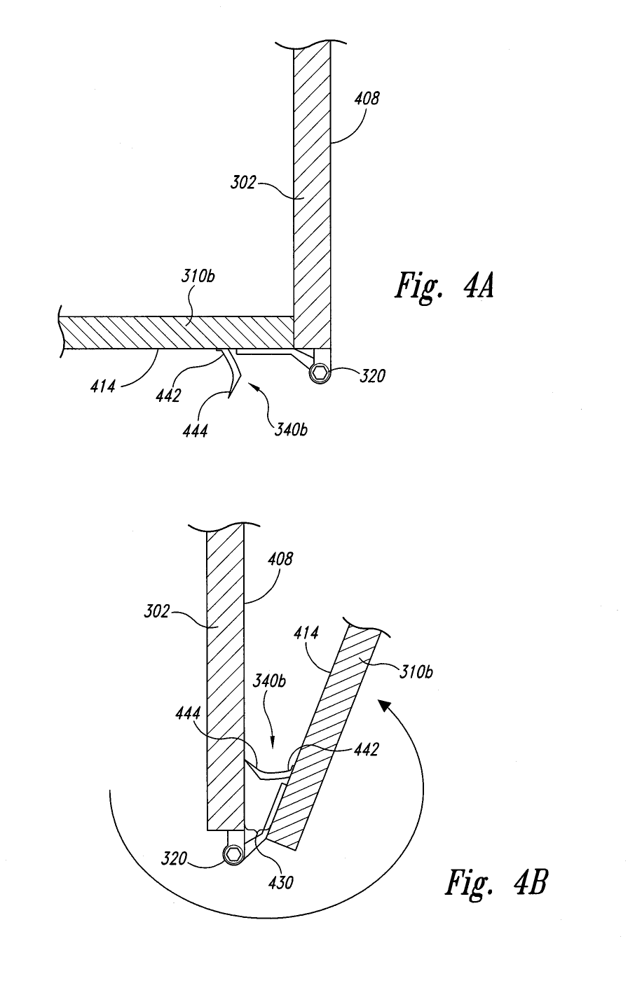

In one aspect of this embodiment, the seals 340 have lengths L that are approximately equal to the height of the corresponding doors 310. In other embodiments, however, the seals 340 can have other lengths, or be formed from multiple shorter segments positioned between the hinges 320. The seals 340 illustrated in FIG. 3 can also include end portions 342 that curve toward the corners of the doors 310 proximate to the hinges 320. As explained below, when the doors 310 rotate open, each seal 340 is at least partially compressed between each of the doors 310 and the container body 302 to seal or occlude the gap therebetween (see, e.g., FIG. 4B). Accordingly, the curved end portions 342 will close off the gap at the upper and lower portions of the doors 310.

FIGS. 4A and 4B are enlarged cross-sectional top views taken along line 4-4 in FIG. 3. In FIG. 4A, the door 310b is closed. In FIG. 4B, the door 310b is opened. As shown in FIG. 4B, the hinges 320 space the opened door 310b apart from the container body 302 to form a gap 430. More specifically, the hinges 320 form the gap 430 between an exterior door surface 414 and an exterior container surface 408. As shown in FIG. 4A in the illustrated embodiment, the seal 340b includes a first seal portion 442 permanently and/or fixedly attached to the exterior door surface 414, and a second seal portion 444 that projects away from the door 310b. In this embodiment, the first seal portion 442 includes a base having a generally flat area for attachment. The second seal portion 444 is spaced apart from the first seal portion 442 and tapers to a relatively sharp edge portion. The second seal portion 444 contacts the exterior container surface 408 so that the seal 340b is at least partially deflected and/or compressed between the adjacent surfaces to at least partially seal or occlude the gap 430.

In the embodiment illustrated in FIGS. 4A and 4B, the seal 340b has a cross-sectional geometry that generally forms an obtuse angle. This geometry allows the second seal portion 444 to deflect or compress toward the first seal portion 442 as the door 310b opens. In certain embodiments however, the first seal portion 442 and the second seal portion 444 can include other geometries or shapes to at least partially seal or occlude the gap 430. For example, the first seal portion 442 and/or the second seal portion 444 can have rectangular, cylindrical, curved, straight or other cross-sectional geometry that is suitable for at least partially sealing the gap 430. In other embodiments, the seal 340b can include a chamber encapsulating a fluid, such as a liquid or gas, that is at least partially compressed between the door 310b and the container body 302 as the door 310b opens.

In an aspect of the illustrated embodiment, the seal 340b is fixedly attached to the door 310b at least proximate to the hinges 320. The seal 340b can be attached with mechanical fasteners, such as screws, bolts, rivets and the like. In other embodiments, however, the seal 340b can be bonded to the door 310b with a suitable adhesive.

The seal 340b illustrated in FIGS. 4A and 4B can be composed of a variety flexible, compressible, and/or resilient materials. In certain embodiments, for example, the seal 340b can be composed of a compressible material such as neoprene, polyurethane foam, elastomer, rubber, or any combination of these and/or other materials. In other embodiments, the seal 340b can be composed of a generally resilient material. For example, the seal 340b can be composed of a plastic or spring steel that can be elastically deflected when the door 310b is opened. One skilled in the art will appreciate that the seal 340b can be formed by a wide variety of suitable manufacturing processes, including, for example, extrusion, injection molding, etc.

The seal 340b (and others described herein) may or may not form a complete seal at the gap 430. Rather, the seal 340b is intended to at least partially seal or otherwise generally occlude the gap 430. Accordingly, the seal 340b can at least reduce the flow of adverse weather, temperature controlled air, and/or other media or objects through the gap 430.

The seal 340b described above with reference to FIGS. 4A and 4B (and other seals and assemblies described herein) overcomes many of the challenges associated with conventional loading dock shelters. For example, differences in the alignment and/or size of the container body 302 are unlikely to adversely affect the performance of the seal 340b. Additionally, differences in the location of the hinges 320 are unlikely to affect the seal 340b. The seal 340b can accommodate these differences because it is attached to the trailer 301, and therefore does not have to engage the gaps 430 from another structure.

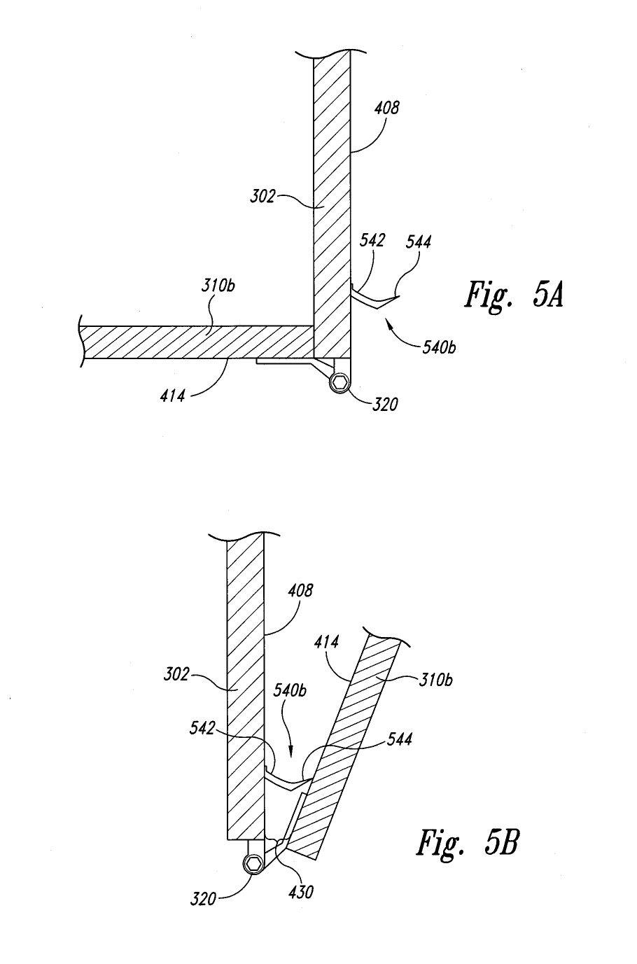

FIGS. 5A-9B are enlarged cross-sectional top views of door seals and assemblies 540b-940b, respectively, configured in accordance with further embodiments of the invention. In the embodiment illustrated in FIGS. 5A and 5B, the seal 540b is generally similar in structure and function to the seal 340b described above with reference to FIGS. 3-4B. In this particular embodiment, however, a first seal portion 542 is bonded or otherwise attached to the exterior container surface 408 proximate to the hinge 320. A second seal portion 544 projects away from the container body 302 far enough so that it contacts the exterior door surface 414 when the door 310b is in the open position, as shown in FIG. 5B. Accordingly, the seal 540b is at least partially deflected or compressed between the container body 302 and the open door 310b to at least partially seal the gap 430.

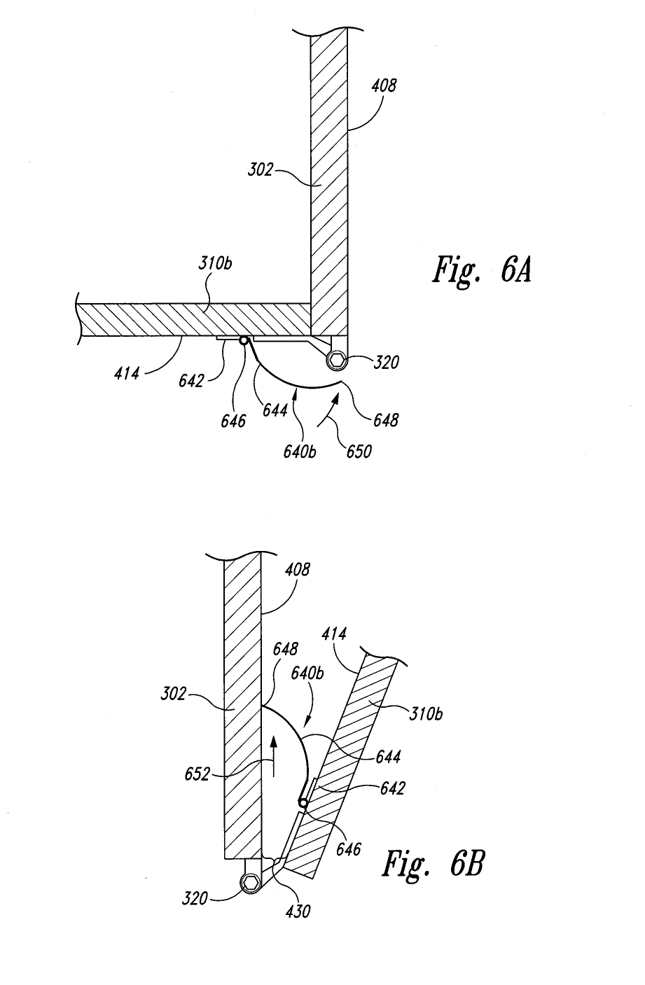

Turning next to FIGS. 6A and 6B, the seal assembly 640b includes a distal edge portion 648 that contacts and slides against the exterior container surface 408 as the door 310b opens. More specifically, the seal assembly 640b includes a first seal portion 642 rotatably connected to a second end portion 644. The first seal portion 642 is fixedly attached to the exterior door surface 414. In certain embodiments, the first seal portion 642 can include a generally flat base that is bolted, screwed, riveted or otherwise permanently attached to the exterior door surface 414. The second seal portion 644 includes the distal edge portion 648 and projects away from the door 310b. The second seal portion 642 can be made from a resilient material and have a generally curved shape. A spring device 646 rotatably connects the first seal portion 642 to the second seal portion 644 and biases the second seal portion 644 in the direction indicated by arrow 650. As shown if FIG. 6B, when the door 310b rotates open, the distal edge portion 648 contacts the exterior container surface 408 and slides away from the hinge 320 in the direction indicated by arrow 652. The second seal portion 644 can bend or flex and the spring device 646 holds the seal assembly 640b in this position to at least partially cover the gap 430.

In one embodiment, the spring device 646 can include a hinge and a torsion spring to connect the first seal portion 642 and the second seal portion 644. In other embodiments, however, the spring device 646 can include other components or configurations suitable for biasing the second seal portion 644 away from the first seal portion 642. For example, in another embodiment, the first seal portion 642, the second seal portion 644, and the spring device 646 can be formed from a single piece of resilient material. For example, in one embodiment the seal assembly 640b can include a single piece of spring steel, plastic, composite material or other material having elastic properties such that it can be deflected and slide as the door 310b opens, but return to its original position as the door 310b closes.

In another aspect of this embodiment, the seal assembly 640b can have a length (not shown) that is approximately equal to the height of the door 310b. In this embodiment, the second seal portion 644 is biased against the hinges 320 when the door 310b is closed as shown in FIG. 6B. In other embodiments, however, the seal assembly 640b can be composed of multiple shorter segments positioned between the hinges 320. Accordingly, in these embodiments the second seal portion 644 is biased against the hinged edge of the container body 302, rather than the hinges 320, when the door 310b is closed. This can reduce the amount of material that is needed to form the seal assembly 640b.

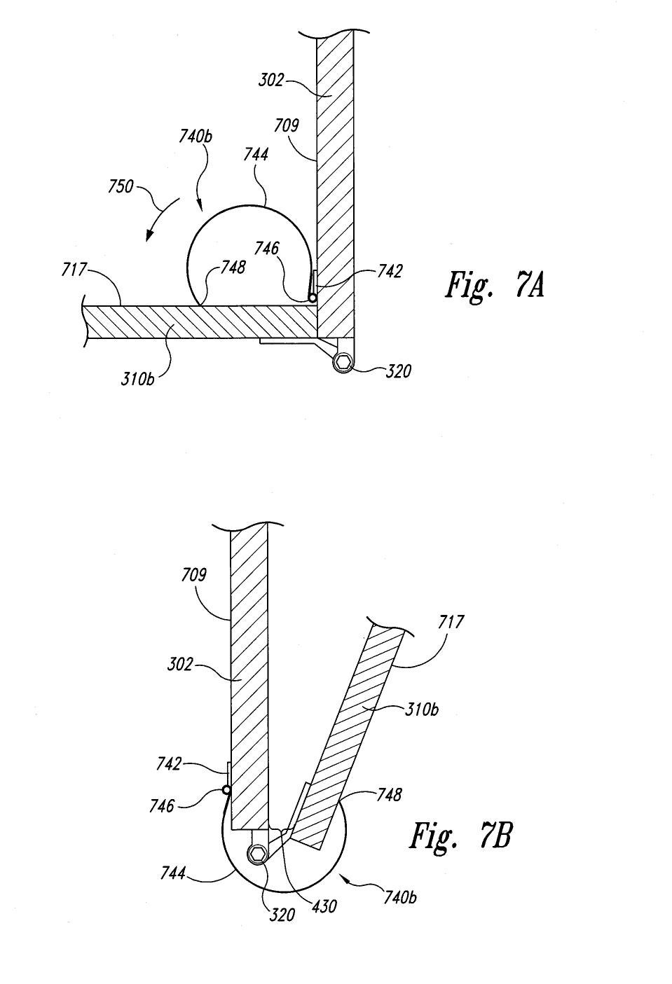

In the embodiment illustrated in FIGS. 7A and 7B, the seal assembly 740b is generally similar in structure and function to the seal assembly 640b described above with reference to FIGS. 6A and 6B. In this particular embodiment, however, the seal assembly 740b is positioned inside the container body 302 when the door 310b is closed, as shown in FIG. 7A. The seal assembly 740b includes a first seal portion 742 attached to an interior container surface 709, and a second seal portion 744 that projects away from the interior container surface 709 toward an interior door surface 717. The second seal portion 744 can be made from a generally resilient material and have a curved or semi-circular cross-sectional shape. A spring device 746 rotatably connects the second seal portion 744 to the first seal portion 742, and biases the second seal portion 744 in the direction indicated by arrow 750. As the door 310b opens, a distal edge portion 748 of the seal assembly 740b remains in contact with the door 310b. More specifically, the distal edge portion 748 slides along the interior door surface 717 toward the hinge 320 as it rotates counter-clockwise in the direction indicated by arrow 750. The spring device 746 holds the seal assembly 740b in this position to at least partially cover the gap 430.

In certain embodiments, the first seal portion 742 and the second seal portion 744 can be separate components joined by the spring device 746. In other embodiments, however, the seal assembly 740b can be formed from a single piece of material including, for example, spring steel, plastic, composite materials, etc. The seal assembly 740b, moreover, can have a length (not shown) approximately equal to the height of the door 310b, or the seal assembly 740b can include multiple shorter segments positioned between the hinges 320.

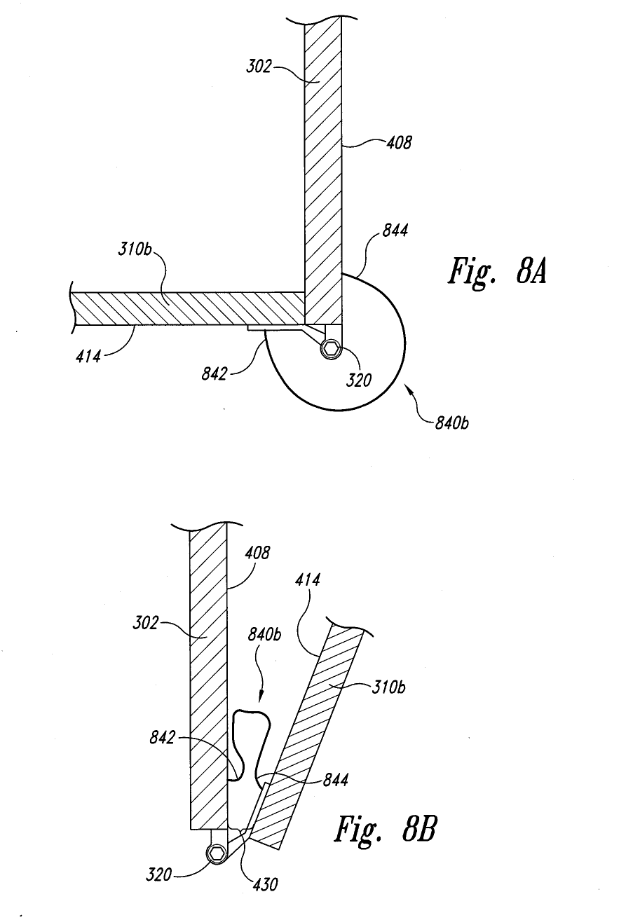

Turning next to FIGS. 8A and 8B, the seal 840b is a flexible seal that is fixedly attached to both the door 310b and the container body 302. More specifically, the seal 840b includes a first edge portion 842 attached to the exterior door surface 414, and a second edge portion 844 attached to the exterior container surface 408. The first and second edge portions 842, 844 can be mechanically attached, bonded, or otherwise permanently attached to the door 310b and container body 302. When the door 310b is in the closed position shown in FIG. 8A, the seal 840b wraps around the outer rear corner of the container body 302 and the hinges 320. When the door 310b is moved to the open position shown in FIG. 8B, the seal 840b retracts between the door 310b and the container body 302 to at least partially seal the gap 430.

In certain embodiments, the seal 840b can be composed of a robust flexible material, such as fabric, elastomer, rubber or other material, to allow the seal 840b to stretch and deform as the door 310b opens and closes. In addition, the seal 840b can have a length (not shown) that is approximately equal to a height of the door 310b such that the seal 840b wraps around and covers the hinges 320 when the door 310b is closed. Similar to the embodiments described above, however, the seal 840b can also include multiple shorter segments positioned between the hinges 320 to avoid covering them when the door 310b is closed.

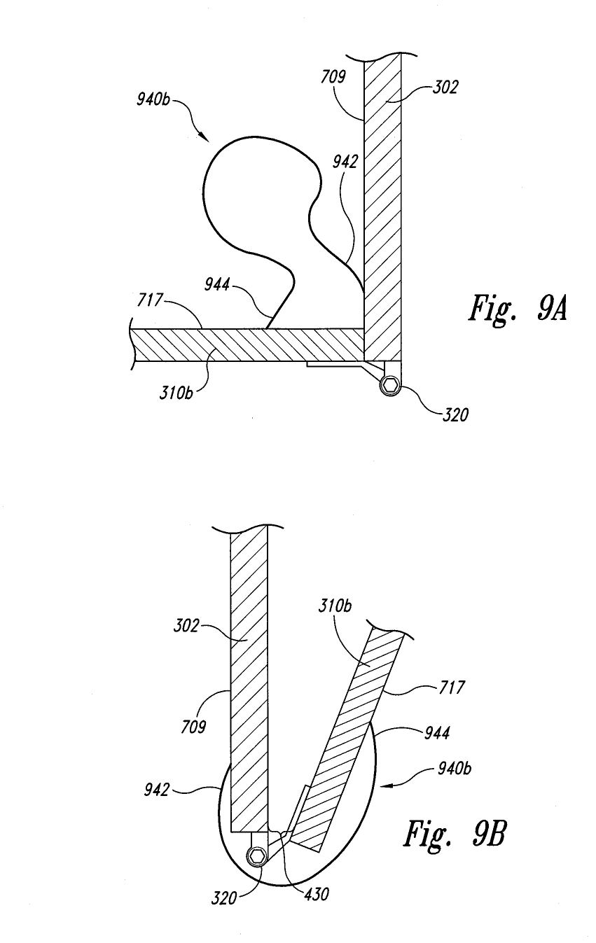

In the embodiment illustrated in FIGS. 9A and 9B, the seal 940b is generally similar in structure and function to the seal 840b described above with reference to FIGS. 8A and 8B. In this particular embodiment, however, the seal 940b includes a first edge portion 942 that is fixedly attached to the interior container surface 709, and a second edge portion 944 that is fixedly attached to the interior door surface 717. Accordingly, when the door 310b is closed, as shown in FIG. 9A, the seal 940b is loosely retracted between the interior surfaces 709, 717. As the door 310b opens, however, the seal 940b extends and covers or wraps around the gap 430, as shown in FIG. 9B.

Similar to the other embodiments described herein, the seal 940b can have a length (not shown) that is approximately equal to the height of the door 310b, such that it wraps around and covers the individual hinges 320 when the door 310b is opened. In other embodiments, however, the seal 940b can include multiple shorter segments positioned between the hinges 320. Accordingly, in these embodiments, the seal 940b does not wrap around or cover the hinges 320 when the door 310b is opened, and less material can be used to form the seal 940b.

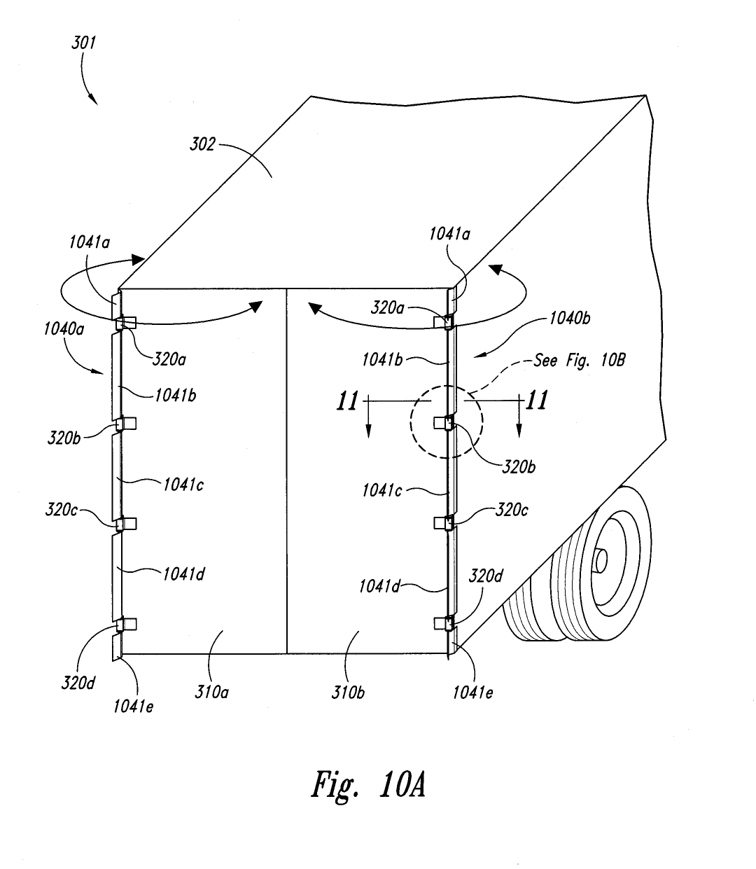

FIG. 10A is an isometric view of the aft portion of the over road trailer 301 having two seal assemblies 1040 (identified individually as a first seal assembly 1040a and a second seal assembly 1040b) configured in accordance with another embodiment of the invention. FIG. 10B is an enlarged isometric view of a portion of the second seal assembly 1040b of FIG. 10A. Referring to FIGS. 10A and 10B together, in the illustrated embodiment the hinges 320 are identified individually as a first hinge 320a, a second hinge 320b, a third hinge 320c, and a fourth hinge 320d. In addition, each of the seal assemblies 1040 includes a plurality of segments 1041 (identified individually as 1041a-1041e) above and below each of the hinges 320a-320d.

In one aspect of this embodiment, each end of each of the seal segments 1041 includes one or more tabs 1045 (as shown in FIG. 10B) that attaches the seal segments 1041 to the adjacent hinges 320. More specifically, the individual tabs 1045 are attached to corresponding hinge pins 1022 in each of the hinges 320 and allow the seal segments 1041 to pivot about a longitudinal axis aligned with the hinge pins 1022.

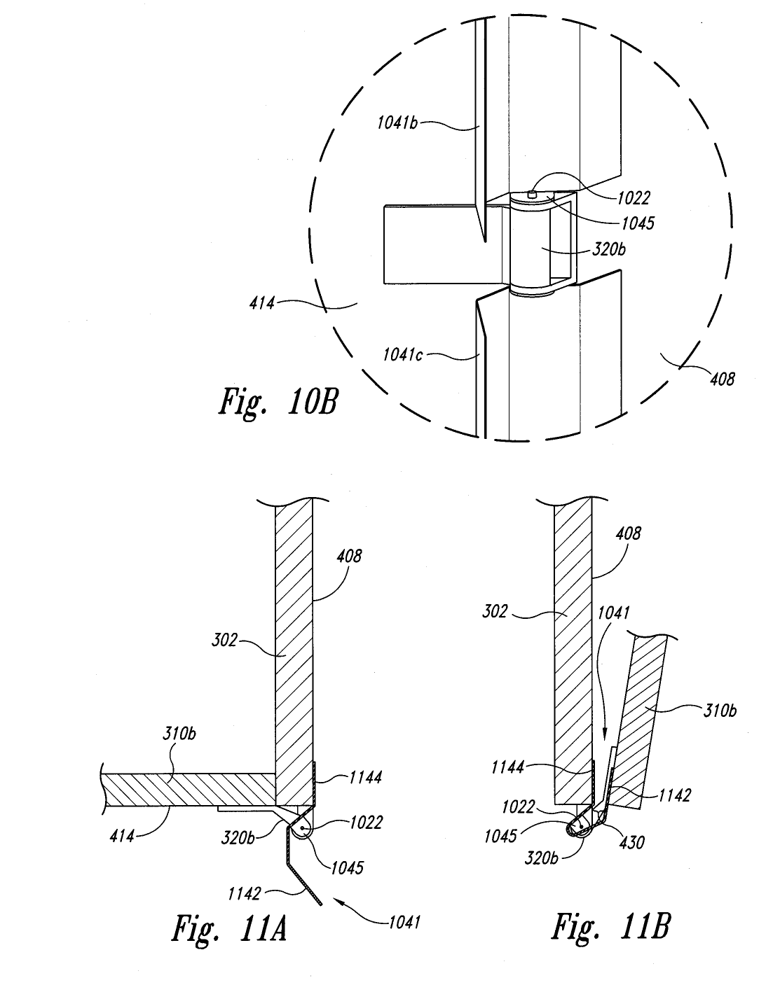

FIGS. 11A and 11B are enlarged cross-sectional top views taken along line 11-11 in FIG. 10A. The door 310b is closed in FIG. 11A and open in FIG. 11B. The seal segment 1041 includes a first seal portion 1142 and a second seal portion 1144 that extend away from the hinge 320 in a predetermined configuration to accommodate the gap 430. In the illustrated embodiment, the second seal portion 1144 is positioned proximate to the exterior container surface 408 and the first seal portion 1142 projects away from the hinge 320b and the door 310b. In one aspect of this embodiment, the second seal portion 1144 can be attached to the exterior container surface 408. In other embodiments, however, the entire seal segment 1041 can rotate about in the hinge pins 1022. As the door 310b swings open, the seal segment 1041 pivots about the hinge pins 1022 until the first and second seal portions 1142, 1144 are squeezed together between the exterior door surface 414 and the exterior container surface 408 to at least partially seal the gap 430. As illustrated in FIG. 11B, the first portion 1142 can at least partially pass over the tab 1045 as the first portion 1142 is deflected towards the second portion 1144. Similar to other embodiments described herein, the seal segment 1041 illustrated in FIGS. 11A and 11B can be made from various types of resilient materials including, for example, spring steel, plastic, composite materials, etc. In other embodiments, however, the seal segment 1041 can be made from compressible materials such as, for example, neoprene, polyurethane foam, elastomer, rubber, and combinations of these or other suitable materials.

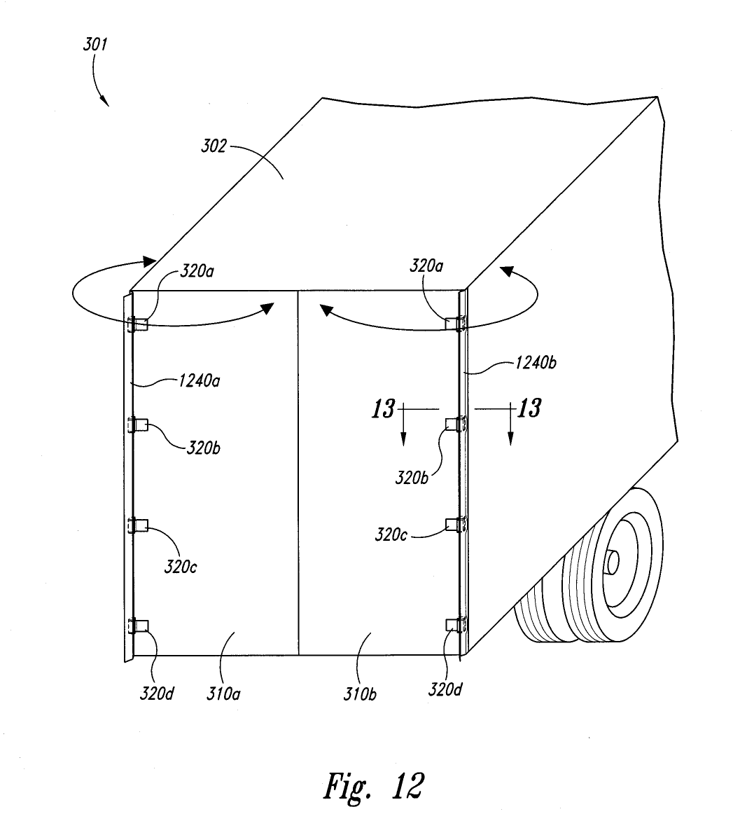

FIG. 12 is an isometric view of the aft portion of the over road trailer 301 having two seal assemblies 1240 (identified individually as a first seal assembly 1240a and a second seal assembly 1240b) configured in accordance with another embodiment of the invention. The seal assemblies 1240 are attached to the hinges 320 and have a configuration generally similar to the seal segments 1041 described above with reference to FIGS. 10A-11B. In this particular embodiment, however, the seal assemblies 1240 extend the length of the doors 310 and do not include multiple shorter segments positioned between the hinges 320.

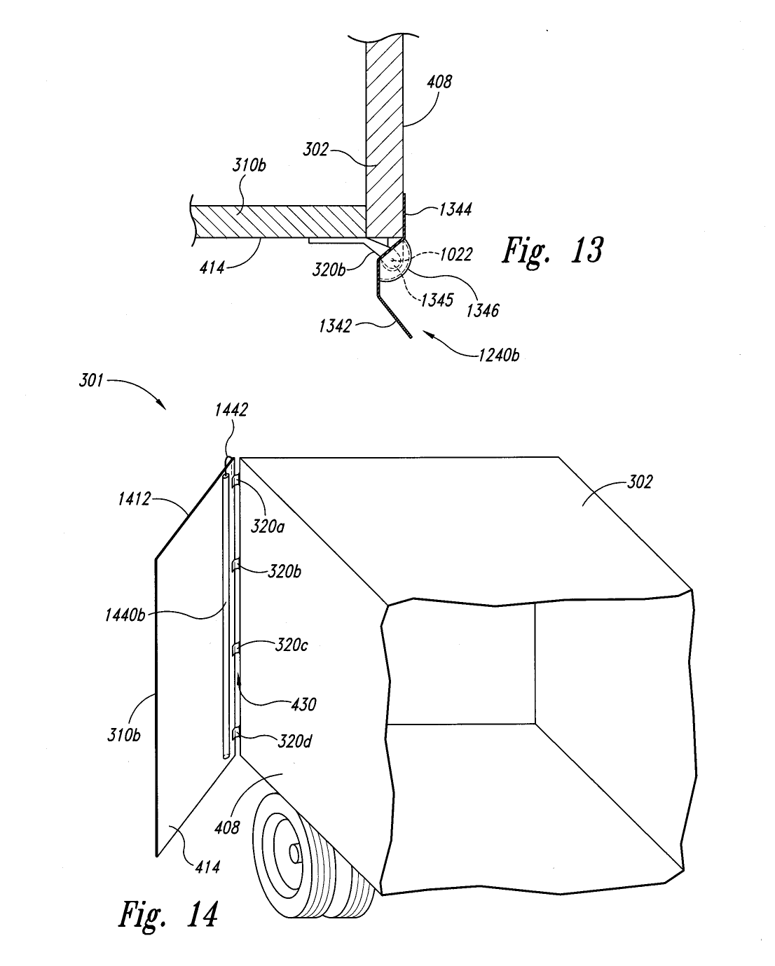

FIG. 13 is an enlarged cross-sectional top view taken along the line 13-13 of FIG. 12 with the door 310b in the closed position. In one aspect of this embodiment, the seal assembly 1240b includes a first seal portion 1342 extending outwardly from the hinge 320, and a second seal portion 1344 positioned proximate to the exterior container surface 408. A tab 1345 (shown in broken lines) pivotally attaches the seal assembly 1240b to the hinge pin 1022 and allows the seal assembly 1240b to pivot about the hinges 320. In the embodiment illustrated in FIG. 13, the seal assembly 1240b includes a cover portion 1346 aligned with the corresponding hinge 320b. Individual cover portions 1346 can be positioned along the seal assemblies 1240 to cover each of the hinges 320a-320d (see, e.g., FIG. 12). The cover portion 1346 can have an arced or dome-like configuration that is attached to the first and second seal portions 1342, 1344 to at least partially envelop or cover the hinge 320b between the first and second seal portions 1342, 1344.

Similar to the embodiments described above with reference to FIGS. 10A-11B, the first seal portion 1342 and the second seal portion 1344 are squeezed or deflected toward each other and at least partially seal the gap 430 (see, e.g., FIG. 11B) when the door 310b is opened. The cover portion 1346 helps to at least partially seal or occlude the gap 430 at the locations of the individual hinges 320 along the seal assembly 1240b. In certain embodiments, the seal assembly 1240b can also be made of various resilient, compressible or other suitable materials similar to the embodiments described above. The cover portion 1346 can be made from a compressible material, such as neoprene, polyurethane foam, elastomer, rubber, etc. Accordingly, as the door 310b opens, the cover portion 1346 can be elastically deformed as the first and second seal portions 1342, 1344 are deflected towards each other.

FIG. 14 is a rear isometric view of the aft portion of the over road trailer 301 illustrating a seal 1440 configured in accordance with another embodiment of the invention. In this embodiment, the door 310b is opened and the seal 1440 is removably attached to the door 310b. More specifically, an engaging device 1442 removably attaches the seal 1440 to a top portion 1412 of the door 310b. In the illustrated embodiment, the engaging device 1442 can have a generally U-shaped geometry, or other shape, suitable for attaching to the top portion 1412 of the door 310b or the container 302. In certain embodiments, for example, the engaging device 1442 can be a hook that fits over the top portion 1412 of the door 310b. In other embodiments, however, the engaging device 1442 can include other suitable apparatuses for removably attaching the seal 1440 to the top portion 1412 or other region of the door 310b or the container body 302.

In the illustrated embodiment, the seal 1440 has a length that is approximately equal to the height of the door 310b. The seal 1440 hangs pendant from the door 310b proximate to the hinges 320 when the door 310b is at least partially open. As the door 310b opens, the exterior door surface 414 compresses the seal 1440 against the exterior container surface 408 to at least partially seal or occlude the gap 430. In one aspect of the illustrated embodiment, the seal 1440 can have a generally circular cross-sectional shape at a plane parallel to its longitudinal axis. In other embodiments, however, the cross-sectional shape can include a rectilinear, triangular, elliptical or other shape suitable for at least partially sealing or occluding the gap 430.

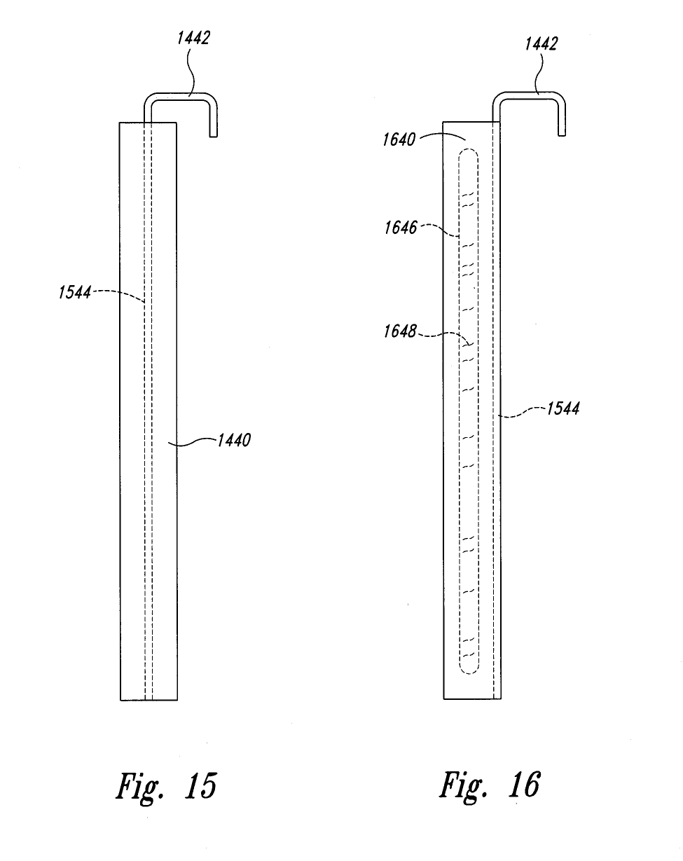

FIG. 15 is an enlarged side view of the seal 1440 and engaging device 1442 illustrated in FIG. 14. In one aspect of this embodiment, the engaging device 1442 can be connected to a rod 1544 (shown in broken lines) extending through the seal 1440. The engaging device 1442 and/or the rod 1544 can be composed of a plastic, wooden, metallic or other material suitable for providing axial support through the seal 1440. In certain embodiments the rod 1544 can be an extension of the engaging device 1442 thereby forming a single piece construction. In other embodiments, however, the rod 1544 can be separate from and coupled to the engaging device 1442.

In another aspect of the embodiment illustrated in FIG. 15, the rod 1544 is approximately centered along the longitudinal axis of the seal 1440 and extends through the full length of the seal 1440. In other embodiments, however, the rod 1544 may not extend through the entire length of the seal 1440 or even be included at all in the seal 1440.

In certain embodiments, the seal 1440 can be composed of a compressible material, such as, for example, neoprene, polyurethane foam, elastomer, rubber, etc. In other embodiments, however, the seal 1440 can be made from rigid materials or other materials suitable for at least partially sealing the gap 430. The seal 1440, moreover, can also be covered with a robust fabric material that can at least partially protect the seal 1440 from the weather or wear from rubbing on the door 310b, container body 302 and hinges 320. One advantage of the configuration shown in FIGS. 14 and 15 is that when the seal 1440 is not in use, it can be stored at a convenient location, such as for example, in the container body 302, at the loading dock, or in the cab of the semi-truck.

FIG. 16 is a side view of a seal 1640 configured in accordance with another embodiment of the invention. The seal 1640 is generally similar in structure and function to the seal 1440 described above with reference to FIGS. 14 and 15. In this particular embodiment, however, the rod 1544 is positioned at a periphery of the seal 1640 rather than aligned with the longitudinal axis of the seal 1640. Positioning the rod 1644 at the periphery allows the seal 1640 to be positioned in close proximity to the exterior door surface 414 when attaching the seal 1640 to the door 310b (as shown in FIG. 14).

In one aspect of this embodiment, the seal 1640 can include an interior chamber 1646 (shown in broken lines). In certain embodiments, the chamber 1646 can have a volume that substantially fills the seal 1640. The chamber 1646 can encapsulate a fluid 1648 (shown in broken lines), such as, for example, a liquid or gas. In certain embodiments, the chamber 1646 can include an inlet or outlet to empty or fill the chamber 1646 with the fluid 1648. Accordingly, when the door 310b opens, the seal 1640, chamber 1646 and fluid 1648 are at least partially compressed to seal or otherwise occlude the gap 430, as shown in FIG. 14.

From the foregoing, it will be appreciated that specific embodiments of the invention have been described herein for purposes of illustration, but that various modifications may be made without deviating from the spirit and scope of the various embodiments of the invention. Further, while various advantages associated with certain embodiments of the invention have been described above in the context of those embodiments, other embodiments may also exhibit such advantages, and not all embodiments need necessarily exhibit such advantages to fall within the scope of the invention. Accordingly, the invention is not limited, except as by the appended claims.

I/We claim:

1. An over road trailer comprising:
a container body having an opening therein;
a door rotatably mounted to the container body proximate the opening, wherein the door moves between a closed position in which the door at least partially covers the opening and an open position in which the door is spaced apart from the opening to form a gap between the door and the container body; and
a seal fixedly attached to at least one of the container body and the door, wherein the seal contacts the container body and the door when the door is in the open position.

2. The trailer of claim 1 wherein the seal is at least partially deflected between the container body and the door when the door is in the open position.

3. The trailer of claim 1 wherein the seal is at least partially compressed between the container body and the door when the door is in the open position.

4. The trailer of claim 1 wherein the seal is permanently attached to the at least one of the container body and the door.

5. The trailer of claim 1 wherein the seal at least partially seals the gap between the container body and the door when the door is in the open position.

6. The trailer of claim 1 wherein an exterior surface of the door at least partially compresses the seal against an exterior surface of the container body.

7. The trailer of claim 1 wherein the seal includes a first seal portion bonded to an exterior surface of the door and a second seal portion projecting away from the exterior surface of the door.

8. The trailer of claim 1 wherein the seal includes a first seal portion bonded to an exterior surface of the container body and a second seal portion projecting away from the exterior surface of the container body.

9. The trailer of claim 1 wherein the seal has a first edge portion fixedly attached to the container body and a second edge portion fixedly attached to the door.

10. The trailer of claim 1 wherein the door is rotatably mounted to the container body along an edge portion of the door, and wherein the seal includes a first end portion, a second end portion opposite the first end portion, and a middle portion between the first and second end portions, wherein the middle portion is generally parallel to the edge portion of the door and at least one of the first and second end portions generally curves toward the edge of the door.

11. An over road cargo carrier comprising:
a container body having an opening therein;
at least one hinge attached to the container body proximate to the opening;
a door rotatably mounted to the container body by the hinge and movable between a closed position in which the door at least partially covers the opening and an open position in which the hinge spaces the door apart from the container body by a gap; and
a seal assembly operably coupled to the at least one hinge, wherein the seal assembly contacts the container body and the door when the door is in the open position.

12. The cargo carrier of claim 11 wherein the seal assembly includes a first seal portion extending away from the hinge in a first direction and a second seal portion extending away from the hinge in a second direction, and wherein the first seal portion contacts the container body and the second seal portion contacts the door when the door is in the open position.

13. The cargo container of claim 12 wherein the seal assembly has a length approximately equal to a height of the door, and wherein the seal assembly includes a cover portion composed of a compressible material that is attached to the first and second seal portions, wherein the cover portion is aligned with the hinge and configured to cover the hinge when the door is in the open position.

14. The cargo carrier of claim 11 wherein the hinge includes a hinge pin and the seal assembly is pivotally attached to the hinge pin.

15. The cargo carrier of claim 11 wherein the at least one hinge includes first, second, third, and fourth hinges, and wherein the seal assembly includes a first seal segment positioned between the first and second hinges, a second seal segment positioned between the second and third hinges, and a third seal segment positioned between the third and fourth hinges.

16. A semi-trailer truck comprising:
a road tractor; and
a semi-trailer operably coupled to the road tractor, wherein the semi-trailer includes:
a container body having an opening therein;
a door rotatably mounted to the container body at least proximate to the opening, wherein the door is movable between a closed position in which the door at least partially covers the opening and an open position in which the door is spaced apart from the opening; and
a seal assembly attached to at least one of the container body and the door, wherein the seal assembly extends between the container body and the door when the door is in the open position.

17. The semi-trailer truck of claim 16 wherein the door has an exterior door surface and the container body has an exterior container surface, and wherein the seal assembly contacts the exterior door surface and the exterior container surface when the door is in the open position.

18. The semi-trailer truck of claim 16 wherein the seal assembly includes a first seal portion attached to an exterior surface of the door and a second seal portion projecting away from the door, and wherein the second seal portion includes a sliding surface that slides against an exterior surface of the container body as the door moves into the open position.

19. The semi-trailer truck of claim 18 wherein the seal assembly further comprises a spring device operably positioned between the first seal portion and the second seal portion, wherein the spring device biases the second seal portion toward the exterior surface of the container body as the door moves into the open position.

20. The semi-trailer truck of claim 16 wherein the seal assembly includes a first seal portion attached to an interior surface of the container body and a second seal portion spaced apart from the first seal portion, wherein the second seal portion includes a sliding surface that slides against an interior surface of the door as the door moves into the open position.

21. The semi-trailer truck of claim 20 wherein the seal assembly further includes a spring operably positioned between the first seal portion and the second seal portion, wherein the spring biases the second seal portion toward the interior surface of the door as the door moves into the open position.

22. The semi-trailer truck of claim 16 wherein the seal assembly includes a first edge portion attached to an exterior surface of the door and a second edge portion attached to an exterior surface of the container body.

23. The semi-trailer truck of claim 16 wherein the seal assembly includes a flexible material having a first portion fixedly attached to an interior surface of the container body and a second portion fixedly attached to an interior surface of the door.

24. The semi-trailer truck of claim 16 wherein the seal assembly includes an engaging device that attaches to a top portion of the door, and wherein the seal assembly hangs from the engaging device and is at least partially compressed between the door and the container body when the door is in the open position.

25. The semi-trailer truck of claim 16 wherein the seal assembly includes a chamber that encapsulates a fluid that is at least partially compressed between the container body and the door when the door is in the open position.

26. A system for shipping cargo over the road by truck, the system comprising:
a container having an opening therein;
means for rotatably mounting a door to the container proximate the opening, wherein the door moves between a closed position in which the door at least partially covers the opening and an open position in which the door is spaced apart from the opening to form a gap therebetween; and
means for at least partially occluding the gap when the door is in the open position, wherein the means for at least partially occluding are fixedly attached to at least one of the door and the container.

27. The system of claim 26 wherein the means for at least partially occluding the gap are at least partially compressed between the door and the container when the door is in the open position.

28. The system of claim 26 wherein the means for at least partially occluding the gap are fixedly attached to at least one of an exterior surface of the door and an exterior surface of the container body.

29. The system of claim 26 wherein the means for at least partially occluding the gap are fixedly attached to at least one of an interior surface of the door and an interior surface of the container body.
